(19) United States
(12) Patent Application Publication
(10) Pub. No.: US 2024/0356638 A1
(43) Pub. Date: Oct. 24, 2024

(54) SWITCHING AVAILABILITY DIAGNOSTIC DEVICE AND OPTICAL SWITCH DEVICE

(71) Applicant: Mitsubishi Electric Corporation, Tokyo (JP)

(72) Inventor: Seiki NAKAMURA, Tokyo (JP)

(73) Assignee: Mitsubishi Electric Corporation, Tokyo (JP)

(21) Appl. No.: 18/758,371

(22) Filed: Jun. 28, 2024

Related U.S. Application Data
(63) Continuation of application No. PCT/JP2022/006049, filed on Feb. 16, 2022.

(51) Int. Cl. H04B 10/079; H04Q 11/00

(52) U.S. Cl. CPC H04B 10/07955; H04Q 11/0005

(57) ABSTRACT

This switching availability diagnostic device includes: a detection unit that receives a partial optical communication signal branched from an optical communication signal on which a diagnostic optical signal having a frequency lower than a frequency of an optical communication signal output from an output port of an optical switch element is superimposed, the optical switch element including one or more input ports and two or more output ports and having an optical path from an input port to an output port, the optical path being switchable, converts the input partial optical communication signal into an electric signal, and extracts an electric signal having a frequency equal to or lower than a set frequency from the converted electric signal as a diagnostic electric signal; and a switching availability diagnostic unit that compares an amplitude value of the diagnostic electric signal extracted by the detection unit with a set threshold.

### CROSS REFERENCE TO RELATED APPLICATIONS

This application is a Continuation of PCT International Application No. PCT/JP2022/006049, filed on Feb. 16, 2022, all of which is hereby expressly incorporated by reference into the present application.

### TECHNICAL FIELD

The present disclosure relates to a switching availability diagnostic device and an optical switch device that diagnose whether or not it is possible to switch an optical path of an M×N optical switch element which includes M input ports and N output ports and in which optical paths from input ports to output ports are changed between the M input ports and the N output ports.

### BACKGROUND ART

In an optical communication network, an optical switch having a plurality of input ports and a plurality of output ports, particularly, a micro-electro-mechanical systems (MEMS) optical switch is used. Patent Literature 1 discloses failure diagnosis for a movable portion of the MEMS optical switch.

Patent Literature 1 describes a MEMS device with failure diagnosis function that switches the position of a movable portion between first and second stable positions in a binary manner by an actuator. This device performs control of failure diagnosis driving for generating a vibration excitation drive signal that positively generates a micro vibration of the movable portion in either of binary switching states, extracts a signal indicating the vibration of the movable portion from a vibration detection means that serves as an electrostatic actuator, and diagnoses a failure.

### CITATION LIST

### Patent Literatures

Patent Literature 1: JP 2006-284746 A

### SUMMARY OF INVENTION

### Technical Problem

The MEMS device with failure diagnosis function disclosed in Patent Literature 1 detects micromechanical vibration of the movable portion, and thus, is likely to be affected by disturbance such as vibration derived from an installation environment and has difficulty in determining whether or not a failure occurs.

The present disclosure solves the above problem, and an object of the present disclosure is to provide a switching availability diagnostic device capable of diagnosing whether or not an optical path of an optical switch element can be switched with an influence of disturbance such as vibration derived from an installation environment being suppressed.

### Solution to Problem

A switching availability diagnostic device that determines whether or not an optical path of an optical switch element in an optical switch device can be switched, according to the present disclosure, includes: a detector to receive a partial optical communication signal branched from an optical communication signal on which a diagnostic optical signal having a frequency lower than a frequency of an optical communication signal output from an output port of an optical switch element is superimposed, the optical switch element having an optical path from an input port to an output port, the optical path being switchable, convert the input partial optical communication signal into an electric signal, and extract an electric signal having a frequency equal to or lower than a set frequency from the converted electric signal as a diagnostic electric signal, the detector receiving a partial optical communication signal branched from an optical communication signal to be input to an input port corresponding to the output port of the optical switch element from which the diagnostic electric signal has been extracted, converting the input partial optical communication signal into an electric signal, and extracting an electric signal having a frequency equal to or lower than a set frequency from the converted electric signal as a reference electric signal; and a determination circuit to compare a difference value between an amplitude value of the diagnostic electric signal extracted by the detector and the amplitude value of the reference electric signal with a set threshold, the determination circuit determining that a normal state is established when the difference value between amplitude values is equal to or greater than the threshold and determining that there is a possibility that switching of the optical path is impossible when the difference value between amplitude values is less than the threshold.

### Advantageous Effects of Invention

According to the present disclosure, it is possible to accurately diagnose whether or not an optical path of an optical switch element of an optical switch device can be switched without being affected by disturbance.

### BRIEF DESCRIPTION OF DRAWINGS

FIG. 1 is a configuration diagram illustrating a configuration of an optical communication station including an optical switch device that includes a switching availability diagnostic device according to a first embodiment.

FIG. 2 is a diagram illustrating an Add/Drop optical path in an Add/Drop state of an optical switch element of the optical switch device including the switching availability diagnostic device according to the first embodiment.

FIG. 3 is a diagram illustrating a Bypass optical path in a Bypass state of the optical switch element of the optical switch device including the switching availability diagnostic device according to the first embodiment.

FIG. 4 is a diagram illustrating a relationship between a drive signal and an output (optical power) from an output port in an optical path during normal operation of the optical switch device including the switching availability diagnostic device according to the first embodiment.

FIG. 5 is a diagram for describing an output (optical power) from an output port in an optical path during a switching availability diagnosis for the optical switch device including the switching availability diagnostic device according to the first embodiment.

FIG. 6 is a diagram illustrating a relationship between the frequency of an optical communication signal and the frequency of a diagnostic optical signal during the switching availability diagnosis for the optical switch device including the switching availability diagnostic device according to the first embodiment.

FIG. 7 is a configuration diagram illustrating each detection unit of the switching availability diagnostic device according to the first embodiment.

### DESCRIPTION OF EMBODIMENTS

### First Embodiment

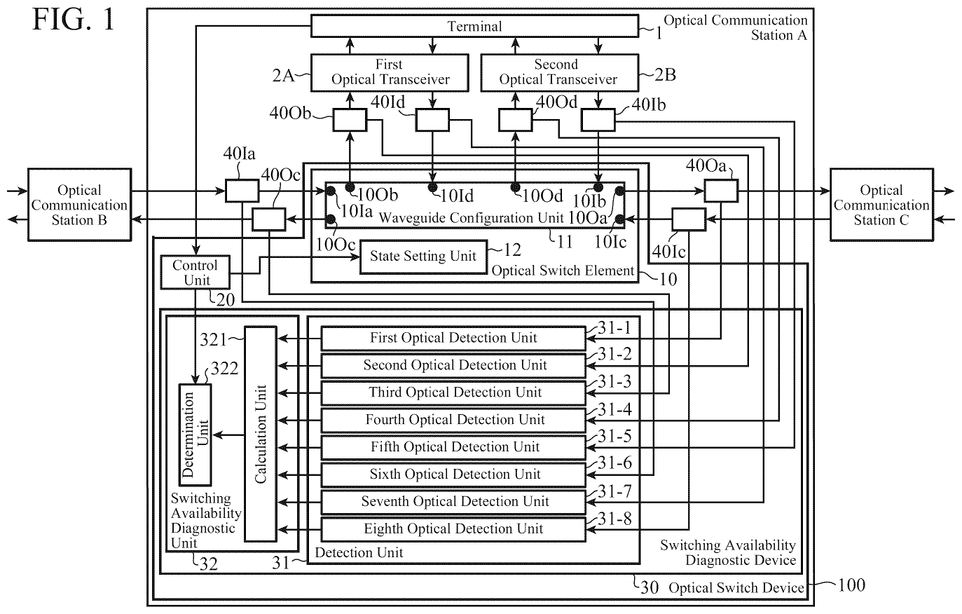

An optical switch device including a switching availability diagnostic device according to a first embodiment will be described with reference to FIGS. 1 to 7. As illustrated in FIG. 1, the optical switch device is disposed in each optical communication station, i.e., optical communication station A, optical communication station B, optical communication station C, . . . connected to an optical communication network.

The optical switch device including the switching availability diagnostic device according to the first embodiment is directed to a double-ring optical network as an optical communication network, and particularly useful when being used as a bypass optical switch device (optical switch). Note that it is not limited to this example, and can be applied to optical switch devices used for various optical networks.

The first embodiment will now be described, taking, as an example, a double-ring optical communication network in which the optical communication station B and the optical communication station C are neighbor nodes connected to the optical communication station A as illustrated in FIG. 1.

Propagation of an optical signal in a route of the optical communication station B—the optical communication station A—the optical communication station C constitutes a first optical communication network, and propagation of an optical signal in a route of the optical communication station C—the optical communication station A—the optical communication station B constitutes a second optical communication network.

That is, a double-ring optical communication network is constructed by the first optical communication network and the second optical communication network.

The first optical communication network and the second optical communication network are configured by optical transmission lines.

The optical communication stations A, B, C, . . . have basically the same configuration, and thus, the optical communication station A will be described as a representative.

The optical communication station A includes a terminal 1, a first optical transceiver 2A, a second optical transceiver 2B, and an optical switch device 100 including a switching availability diagnostic device 30 according to the first embodiment.

The optical switch device 100 includes an optical switch element 10, a control unit 20, and the switching availability diagnostic device 30.

The terminal 1 processes a communication electric signal obtained by converting an optical communication signal which propagates through the first optical communication network from the optical communication station B and is input into the first optical transceiver 2A through the optical switch element 10 into an electric signal by the first optical transceiver 2A. The terminal 1 also transmits, to the optical communication station C through the optical switch element 10 and the first optical communication network, an optical communication signal obtained by conversion of the communication electric signal, which is, for example, a result of the processing, by the second optical transceiver 2B.

The terminal 1 processes a communication electric signal obtained by converting an optical communication signal which propagates through the second optical communication network from the optical communication station C and is input into the second optical transceiver 2B through the optical switch element 10 into an electric signal by the second optical transceiver 2B. The terminal 1 also transmits, to the optical communication station B through the optical switch element 10 and the second optical communication network, an optical communication signal obtained by conversion of the communication electric signal, which is, for example, a result of the processing, by the first optical transceiver 2A.

The terminal 1 outputs a drive instruction signal for controlling the optical switch element 10 to the control unit 20 of the optical switch device 100.

The first optical transceiver 2A is connected to the first optical communication network and the second optical communication network via the optical switch element 10, and performs optical communication with a second optical transceiver included in the optical communication station B.

The second optical transceiver 2B is connected to the first optical communication network and the second optical communication network via the optical switch element 10, and performs optical communication with a first optical transceiver included in the optical communication station C.

Each of the first optical transceiver 2A and the second optical transceiver 2B is an optical transceiver and uses an optical communication system in accordance with a specification conforming to a standard or a proprietary specification. Main signal light thereof has a frequency spectrum depending on an optical modulation system, a modulation frequency, and an encoding system, and is, for example, high-speed modulation light such as non-return-zero (NRZ) intensity modulation light that is 8-bit/10-bit encoded for 1.25 Gbit/s or NRZ intensity modulation light that is 64-bit/66-bit encoded for 10 Gbit/s.

The main signal light is an optical communication signal propagated through the first optical communication network and the second optical communication network.

Each of the first optical transceiver 2A and the second optical transceiver 2B is an optical transceiver commonly used in the relevant field.

Each of the first optical transceiver 2A and the second optical transceiver 2B is designed to be subjected to ΔC coupling by capacitance at the reception stage and to respond at a frequency equal to or higher than the lower limit cutoff frequency.

That is, each of the first optical transceiver 2A and the second optical transceiver 2B does not respond to a low-frequency region less than the lower limit cutoff frequency.

The cutoff frequency is set to a frequency sufficiently lower than the frequency band of a signal level of the optical communication signal.

As for the cutoff frequency of each of the first optical transceiver 2A and the second optical transceiver 2B, the lower limit cutoff frequency fc (=½ πRC) of a CR filter by capacitance C and termination resistance R is 31.8 kHz where, for example, the capacitance C is 0.1 μF and the termination resistance R is 50 ohm.

In addition, each of the first optical transceiver 2A and the second optical transceiver 2B includes a gain control circuit, and can respond to power fluctuation within a level range set for received light.

The optical switch element 10 is an M×N optical switch element having M input ports and N output ports. The optical switch element 10 is switchable to either of two states, an add/drop (Add/Drop) state and a bypass (Bypass) state, by a drive signal from the control unit 20.

M is a natural number equal to or more than 1, and Nis a natural number equal to or more than 2.

The add/drop state and the bypass state will be described as Add/Drop state and Bypass state, respectively.

In the first embodiment, a bypass (4×4) optical switch element in which the number M of input ports is four and the number N of output ports is four will be described as an example.

Note that, in a case of one optical communication network instead of the double-ring optical communication network, the optical switch element 10 is a (2×2) optical switch element. In a case of three optical communication networks, the optical switch element 10 is a (6×6) optical switch element. The optical switch element 10 in a ring network multiplexed n times (n is a natural number) is a (2n×2n) optical switch element. In some optical communication networks, the optical switch element 10 is a (1×2) optical switch element.

In addition, the optical switch element 10 is not limited to a bypass optical switch element, and may be an optical switch element having two states that are an optical path during operation and an optical path during non-operation, that is, may be an optical switch element in which an optical path from an input port to an output port is changed by a switching operation.

Specifically, the number M of input ports and the number N of output ports in the optical switch element 10 are selected depending on the optical communication network.

It is to be noted that, in the first embodiment, in response to the drive signal from the control unit 20 that receives a drive instruction signal from the terminal 1, the optical switch element 10 switches to either of two optical paths which are an add/drop (Add/Drop) optical path that terminates the optical communication signal to the first optical transceiver 2A and the second optical transceiver 2B and a bypass (Bypass) optical path that allows the optical communication signal propagated to the optical communication station B and the optical communication station C, which are the next optical communication stations, to pass.

The add/drop optical path and the bypass optical path will be described as Add/Drop optical path and Bypass optical path, respectively.

In response to the drive signal from the control unit 20, the optical switch element 10 is set to the Add/Drop state during operation to form the Add/Drop optical path for connecting the first optical transceiver 2A and the second optical transceiver 2B to the first optical communication network and the second optical communication network so as to enable the optical communication station A to perform optical communication with the optical communication station B and the optical communication station C.

In addition, when it is necessary to disconnect the terminal 1 from the first optical communication network and the second optical communication network at the time of occurrence of an abnormality such as a power failure or a failure in the optical communication station A or for the reason of inspection or the like, the optical switch element 10 is set to the Bypass state to form the Bypass optical path. That is, the first optical communication network and the second optical communication network are connected to the optical communication station B and the optical communication station C by skipping the optical communication station A in such a manner that the optical communication with the optical communication station B and the optical communication station C is maintained.

Further, in the Add/Drop state, the optical switch element 10 outputs an optical communication signal on which a diagnostic optical signal having a frequency lower than the frequency of the optical communication signal is superimposed from at least one output port among the plurality of output ports at the time of diagnosing whether or not it is possible to perform switching from the Add/Drop optical path to the Bypass optical path.

The optical communication signal on which the diagnostic optical signal is superimposed is signal light obtained by modulating an optical power distribution factor of the optical communication signal itself by the frequency of the diagnostic optical signal.

As for the frequency of the diagnostic optical signal, the frequency of a diagnostic electric signal obtained by converting the diagnostic optical signal into an electric signal is a frequency that is less than the cutoff frequency of the first optical transceiver 2A and the second optical transceiver 2B.

The first embodiment will describe below an example in which a (4×4) optical switch element is used as the optical switch element 10.

Note that a configuration in which (2×2) optical switch elements are coupled in two stages is also included in (4×4) optical switch element.

The four input ports of the optical switch element 10 are a first input (IN) port 10Ia, a first add (ADD) port 10Ib, a second input (IN) port 10Ic, and a second add (ADD) port 10Id.

The four output ports of the optical switch element 10 are a first output (OUT) port 10Oa, a first drop (DROP) port 10Ob, a second output (OUT) port 10Oc, and a second drop (DROP) port 10Od.

An optical fiber with optical connector is connected to each of the four input ports and the four output ports as an optical interface for connection with the outside.

In the following, the input port is referred to as IN port, the add port is referred to as ADD port, the output port is referred to as OUT port, and the drop port is referred to as DROP port.

In addition, in the following description, the four input ports are simply referred to as input port when they are commonly described, the four output ports are simply referred to as output port when they are commonly described, and the four input ports and the four output ports are simply referred to as port when they are commonly described, in order to avoid complexity of the description.

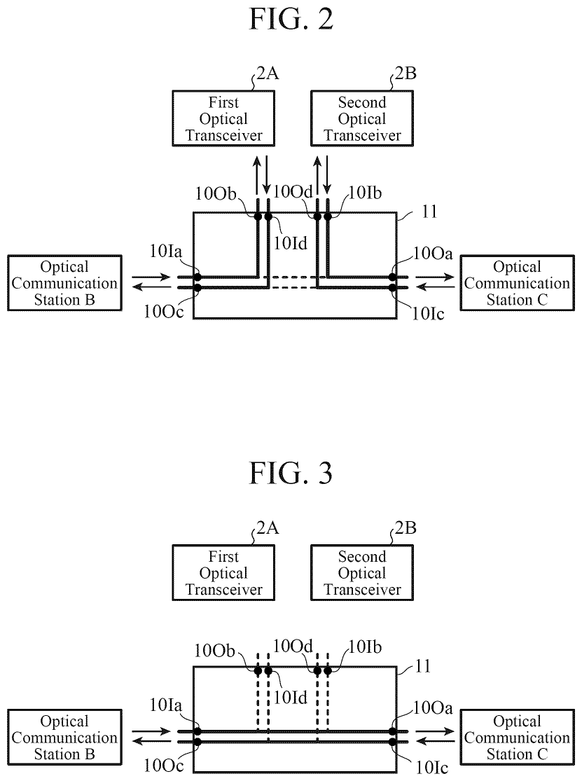

As illustrated in FIG. 2, the Add/Drop optical path indicates an optical path from the first IN port 10Ia to the first DROP port 10Ob and an optical path from the first ADD port 10Ib to the first OUT port 10Oa with respect to the first optical communication network, and an optical path from the second IN port 10Ic to the second DROP port 10Od and an optical path from the second ADD port 10Id to the second OUT port 10Oc with respect to the second optical communication network.

As illustrated in FIG. 3, the Bypass optical path indicates an optical path from the first IN port 10Ia to the first OUT port 10Oa with respect to the first optical communication network, and an optical path from the second IN port 10Ic to the second OUT port 10Oc with respect to the second optical communication network.

The first IN port 10Ia is connected to an optical transmission line constituting the first optical communication network by the optical fiber with optical connector, and receives an optical communication signal from the optical communication station B via the optical transmission line.

The first DROP port 10Ob is connected to the first optical transceiver 2A by the optical fiber with optical connector, and outputs the optical communication signal input to the first IN port 10Ia to the first optical transceiver 2A in the Add/Drop state.

The first ADD port 10Ib is connected to the second optical transceiver 2B by the optical fiber with optical connector, and receives the optical communication signal which has been processed by the terminal 1 and is output from the second optical transceiver 2B.

The first OUT port 10Oa is connected to an optical transmission line constituting the first optical communication network by the optical fiber with optical connector, and outputs, to the optical communication station C via the optical transmission line, an optical communication signal input to the first ADD port 10Ib in the Add/Drop state and an optical communication signal input to the first IN port 10Ia in the Bypass state.

The second IN port 10Ic is connected to an optical transmission line constituting the second optical communication network by the optical fiber with optical connector, and receives an optical communication signal from the optical communication station C via the optical transmission line.

The second DROP port 10Od is connected to the second optical transceiver 2B by the optical fiber with optical connector, and outputs the optical communication signal input to the second IN port 10Ic to the second optical transceiver 2B in the Add/Drop state.

The second ADD port 10Id is connected to the first optical transceiver 2A by the optical fiber with optical connector, and receives the optical communication signal which has been processed by the terminal 1 and is output from the first optical transceiver 2A.

The second OUT port 10Oc is connected to an optical transmission line constituting the second optical communication network by the optical fiber with optical connector, and outputs, to the optical communication station B via the optical transmission line, an optical communication signal input to the second ADD port 10Id in the Add/Drop state and an optical communication signal input to the second IN port 10Ic in the Bypass state.

The optical switch element 10 includes a waveguide configuration unit 11 and a state setting unit 12.

The waveguide configuration unit 11 has M (a natural number equal to or more than 1) input ports, N (a natural number equal to or more than 2) output ports, M waveguides corresponding to the M input ports, and N waveguides corresponding to the N output ports, and switches to the Add/Drop optical path or the Bypass optical path by the operation of the state setting unit 12.

In the first embodiment, the waveguide configuration unit 11 includes four input ports, four output ports, eight waveguides each of which has one end connected to the corresponding one of the eight ports and the other end disposed at the center, and a rerouting unit disposed at the center of the eight waveguides.

The four input ports are the first IN port 10Ia, the first ADD port 10Ib, the second IN port 10Ic, and the second ADD port 10Id, and the four output ports are the first OUT port 10Oa, the first DROP port 10Ob, the second OUT port 10Oc, and the second DROP port 10Od.

The waveguide configuration unit 11 changes the optical connection relationship of the eight waveguides by the rerouting unit, forms the Add/Drop optical path illustrated in FIG. 2 in the Add/Drop state, forms the Bypass optical path illustrated in FIG. 3 in the Bypass state, and outputs an optical communication signal on which the diagnostic optical signal is superimposed from at least one output port among the four output ports during the switching availability diagnosis.

At the time of the switching availability diagnosis, the optical communication signal output from the output port is signal light obtained by modulating optical power of the optical communication signal itself with a diagnostic drive signal having a frequency lower than the frequency of the optical communication signal.

The state setting unit 12 receives the drive signal from the control unit 20, and performs an operation of causing the rerouting unit of the waveguide configuration unit 11 to switch the optical coupling relationship between the input port and the output port, that is, to switch to either the Add/Drop optical path or the Bypass optical path.

In addition, the state setting unit 12 performs an operation of causing the waveguide configuration unit 11 to output the optical communication signal on which the diagnostic optical signal is superimposed from at least one output port at the time of the switching availability diagnosis.

In short, the optical switch element 10 is an optical module in which the state setting unit 12 operates in response to the drive signal from the control unit 20, and the state setting unit 12 mechanically moves or rotates or electrically displaces a movable portion in the waveguide configuration unit 11, thereby switching the optical coupling relationship (optical path) between the input port and the output port.

Preferably, the optical switch element 10 may have a structure that does not have wavelength selectivity and does not require complicated control.

The optical switch element 10 is, for example, an optical switch element generally known in the relevant field. Examples of the optical switch element 10 include a mechanical-relay optical switch element, a micro-electro-mechanical systems (MEMS) optical switch element such as an electrostatic drive type, an optical-waveguide optical switch element (silicon-based optical device: Si-Ph) by optical interference, and an interferometer type optical switch element that switches an optical path by non-mechanically controlling an optical phase to cause interference, or the like.

In a case where the MEMS optical switch element or the mechanical-relay optical switch element is used, the waveguide configuration unit 11 is a movable optical component including a spatial optical system, a waveguide including a fiber or formed on a semiconductor substrate, and a movable portion such as a movable (micro) mirror, a prism, or a fiber, and the state setting unit 12 is an optical path switching unit that displaces the movable portion of the waveguide configuration unit 11 such as an electrostatic actuator, an electromagnetic relay, or a solenoid motor.

Further, in the optical-waveguide optical switch element, the waveguide configuration unit 11 includes a waveguide formed on a semiconductor substrate and an optical phase shift unit that is a movable portion, and the state setting unit 12 is an optical path switching unit that applies a voltage to the optical phase shift unit.

The MEMS optical switch element or the mechanical optical switch element has a structure in which, for example, an electrostatic actuator is displaced by the drive signal, and a movable mirror which is disposed at the center where the other ends of the plurality of waveguides are arranged and which is attached to the tip of the electrostatic actuator is inserted and removed by the operation of the electrostatic actuator to switch the optical path.

Note that the MEMS optical switch element or the mechanical optical switch element may include passive optical components such as a lens and a collimator in order to improve optical coupling efficiency, suppress optical crosstalk, and prevent light reflection.

The control unit 20 receives the drive instruction signal from the terminal 1, and supplies, to the state setting unit 12 of the optical switch element 10, the drive signal during the normal operation and the diagnostic drive signal during the switching availability diagnosis.

The control unit 20 outputs a drive state signal to the switching availability diagnostic device 30.

The drive signal from the control unit 20 is an electric signal that is determined by the internal structure and characteristics of the optical switch element 10, and is an electric signal that supplies, from the state setting unit 12 to the waveguide configuration unit 11, power enough to maintain either the Add/Drop optical path or the Bypass optical path or to switch between the Add/Drop optical path and the Bypass optical path during the normal operation in which the terminal 1 is operating or is not operating.

In addition, the diagnostic drive signal from the control unit 20 is an electric signal sufficient to superimpose a diagnostic optical signal having a frequency lower than the frequency of the optical communication signal on the optical communication signal.

The drive state signal from the control unit 20 is an electric signal indicating whether the optical switch element 10 performs the normal operation or a switching availability diagnostic operation.

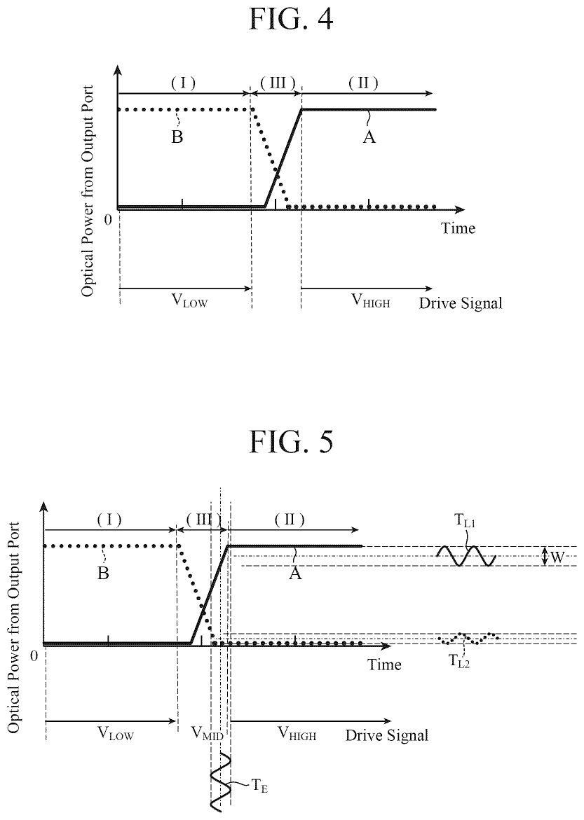

The relationship between the drive signal from the control unit 20 and outputs (power) of the optical path in the state setting unit 12, the waveguide configuration unit 11, and the two states during the normal operation will be described with reference to FIG. 4.

When the drive instruction signal from the terminal 1 indicates the Bypass state, the drive signal from the control unit 20 supplies a low-level drive signal to the state setting unit 12, and the state setting unit 12 operates to hold the optical path of the waveguide configuration unit 11 as the Bypass optical path.

The low-level of the drive signal is a DC or AC voltage V_{LOW} [V] or a ground potential sufficient to stably hold the Bypass state, or a potential of a non-application signal that brings the Bypass state when no power is supplied.

By holding the optical path of the waveguide configuration unit 11 as the Bypass optical path, the relationship between the optical power of the input port and the optical power of the output port is as follows.

Note that an optical insertion loss, an optical crosstalk, and the influence of light reflection and the like will not be considered for easy understanding without complexity of the description. Therefore, in the following, although the optical power is described as 0% and 100%, the optical power is not exactly 0% and 100%, and is approximately 0% and 100%.

With respect to the optical power of the optical communication signal input to the first IN port 10Ia, the optical power to the first DROP port 10Ob is 0%, and the optical power to the first OUT port 10Oa is 100%.

With respect to the optical power of the optical communication signal input to the second IN port 10Ic, the optical power to the second DROP port 10Od is 0%, and the optical power to the second OUT port 10Oc is 100%.

With respect to the optical power of the optical communication signal input to the first ADD port 10Ib, the optical power to the first OUT port 10Oa is 0%, and the optical power to the second DROP port 10Od is 0% or 100%.

With respect to the optical power of the optical communication signal input to the second ADD port 10Id, the optical power to the second OUT port 10Oc is 0%, and the optical power to the first DROP port 10Ob is 0% or 100%.

The output ports indicating 100% optical power relative to the input ports, in this example, the first OUT port 10Oa and the second OUT port 10Oc, are referred to as output of the Bypass optical path.

In FIG. 4, a region indicated by (I) is a region of the Bypass state, an output of the Bypass optical path is indicated by a broken line B, and optical power from the output port is indicated as 100%.

In this case, since the Add/Drop optical path is not formed, the output of the Add/Drop optical path is indicated as 0% as indicated by a solid line A.

That is, in the Bypass state, the Bypass optical path propagates 100% of the optical power of the optical communication signal input to the input port to the output port, and the optical communication signal is exchanged between the optical communication station B and the optical communication station C.

When the drive instruction signal from the terminal 1 indicates the Add/Drop state, the drive signal from the control unit 20 supplies a high-level drive signal to the state setting unit 12, and the state setting unit 12 operates to hold the optical path of the waveguide configuration unit 11 as the Add/Drop optical path.

The high-level of the drive signal is a DC or AC voltage V_{HIGH} [V] sufficient to stably hold the Add/Drop state.

With respect to the optical power of the optical communication signal input to the first IN port 10Ia, the optical power to the first DROP port 10Ob is 100%, and the optical power to the first OUT port 10Oa is 0%.

With respect to the optical power of the optical communication signal input to the second IN port 10Ic, the optical power to the second DROP port 10Od is 100%, and the optical power to the second OUT port 10Oc is 0%.

With respect to the optical power of the optical communication signal input to the first ADD port 10Ib, the optical power to the first OUT port 10Oa is 100%, and the optical power to the second DROP port 10Od is 0%.

With respect to the optical power of the optical communication signal input to the second ADD port 10Id, the optical power to the second OUT port 10Oc is 100%, and the optical power to the first DROP port 10Ob is 0%.

The output ports indicating 100% optical power relative to the input ports, in this example, the first DROP port 10Ob, the second DROP port 10Od, the first OUT port 10Oa, and the second OUT port 10Oc, are referred to as output of the Add/Drop optical path.

In FIG. 4, a region indicated by (II) is a region of the Add/Drop state, an output of the Add/Drop optical path is indicated by the solid line A, and optical power from the output port is indicated as 100%.

In this case, since the Bypass optical path is not formed, the output of the Bypass optical path is indicated as 0% as indicated by the broken line B.

That is, in the Add/Drop state, the Add/Drop optical path propagates 100% of the optical power of the optical communication signal input to the input port to the output port, and the optical communication station A exchanges the optical communication signal with the optical communication station B and the optical communication station C.

During the switching availability diagnosis, in the Add/Drop state, the control unit 20 outputs a diagnostic electric signal TE which is a diagnostic drive signal to the state setting unit 12 of the optical switch element in such a manner that a diagnostic optical signal T_{L1} that varies in a variation range W between a value of a signal level (optical power) of an optical communication signal which is an output of the Add/Drop optical path in the Add/Drop state, and a value of a signal level (optical power) of an optical communication signal which is an output of the Add/Drop optical path in a shift region (III) immediately before the Add/Drop state region (II) is superimposed on the optical communication signal which is an output of the Add/Drop optical path, as illustrated in FIG. 5.

That is, the diagnostic electric signal TE is an AC signal that varies between a voltage V_{HIGH} [V] that is high enough to stably hold the Add/Drop state and a lower limit voltage V_{MID} [V] lower than V_{HIGH} [V] by a set voltage and higher than V_{LOW} [V].

The shift region (III) indicates a region where a state change from the Bypass state to the Add/Drop state occurs between the Bypass state region (I) and the Add/Drop state region (II) as illustrated in FIG. 5.

In addition, in this example, the control unit 20 determines a timing of the switching availability diagnosis, that is, the timing of supplying the diagnostic electric signal TE to the state setting unit 12, and the switching availability diagnosis is autonomously and periodically performed every time a constant period elapses. Note that the control unit 20 may execute the switching availability diagnosis on the basis of an instruction from the terminal 1.

Further, the switching availability diagnosis may be constantly performed during the Add/Drop state. In this case, the control unit 20 constantly supplies the diagnostic electric signal TE to the state setting unit 12 during the Add/Drop state.

The diagnostic electric signal TE is an AC signal having a frequency lower than the frequency of the optical communication signal and lower than the cutoff frequency of the first optical transceiver 2A and the second optical transceiver 2B or a signal equivalent to the AC signal.

Upon receiving the diagnostic electric signal TE, the state setting unit 12 superimposes the diagnostic optical signal T_{L1} that varies in the variation range W between the signal level (optical power) of the optical communication signal, which is the output of the Add/Drop optical path, in the region (II) and the signal level (optical power) in the region (III) on the optical communication signal, which is the output of the Add/Drop path, in response to the diagnostic electric signal TE, that is, outputs the optical communication signal obtained by optically modulating the optical communication signal with the diagnostic optical signal T_{L1} from the output port of the Add/Drop optical path of the waveguide configuration unit 11.

At the same time, a low-frequency optical signal T_{L2} having a phase substantially opposite to that of the diagnostic optical signal T_{L1} is output from the output port of the Bypass optical path on the basis of the distribution factor with respect to the output port of the Add/Drop optical path as illustrated in FIG. 5.

That is, the movable portion of the waveguide configuration unit 11 is driven at a low speed by the diagnostic electric signal TE from the state setting unit 12 in such a manner that the output optical power is distributed between the Add/Drop optical path and the Bypass optical path, that is, a part of the output of the Add/Drop optical path is distributed to the output of the Bypass optical path by changing the distribution factor.

In addition, the time-averaged optical power in the output of the Add/Drop optical path is sufficiently larger than the time-averaged optical power in the output of the Bypass optical path.

As a result, when attention is paid to the optical communication signals output from the output ports with respect to the optical communication signals to be input to the respective input ports in the Add/Drop optical path, that is, the optical communication signals output from the first OUT port 10Oa to the first ADD port 10Ib, from the first DROP port 10Ob to the first IN port 10Ia, from the second OUT port 10Oc to the second ADD port 10Id, and from the second DROP port 10Od to the second IN port 10Ic, low-frequency optical intensity modulation based on the diagnostic electric signal TE is superimposed on the optical communication signal to be input to the input port and the optical communication signal on which the low-frequency diagnostic optical signal is superimposed is output from the output port.

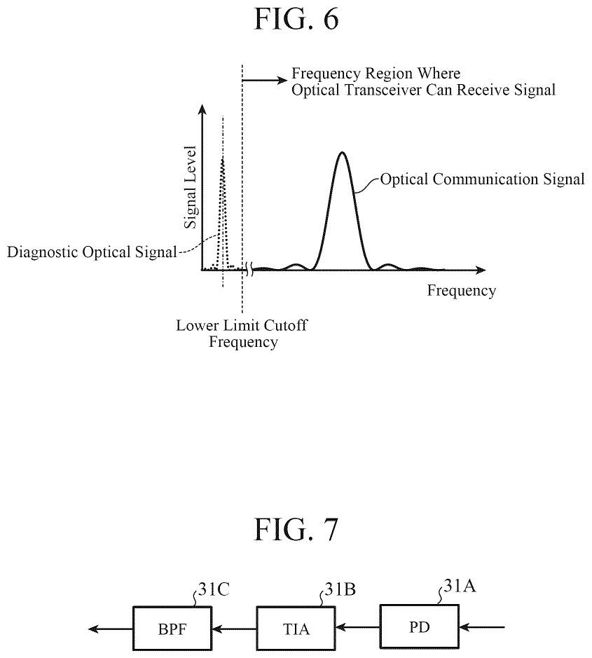

Regarding the relationship between the frequencies of the diagnostic optical signal T_{L1} and the optical signal T_{L2} which are modulation signals for the optical communication signal, and the frequency of the optical communication signal, the frequency of the diagnostic optical signal T_{L1} is a low frequency lower than the cutoff frequency of the first optical transceiver 2A and the second optical transceiver 2B as illustrated in FIG. 6 representing an image of a frequency spectrum. That is, the frequencies of the diagnostic optical signal T_{L1} and the optical signal T_{L2} are set to be sufficiently lower than the frequency band of the optical communication signal.

In addition, the amplitudes (signal power) of the diagnostic optical signal T_{L1} and the optical signal T_{L2} are set to sufficiently small values with respect to the amplitude (signal power) of the optical communication signal.

The variation range W of the diagnostic optical signal T_{L1} is set within a fluctuation range of the optical power received by the first optical transceiver 2A and the second optical transceiver 2B.

Therefore, the diagnostic optical signal T_{L1} and the optical signal T_{L2} do not affect the double-ring optical network, and have frequencies cut by the first optical transceiver 2A and the second optical transceiver 2B in the optical communication station, whereby they do not affect the terminal 1.

In a case where a MEMS optical switch element or a mechanical optical switch element is used as the optical switch element 10, the optical path switching unit which is the state setting unit 12 and which has received the diagnostic electric signal TE mechanically oscillates or resonates the movable portion of the movable optical component which is the waveguide configuration unit 11, thereby performing an optical intensity modulation on the optical communication signal which is the output of the Add/Drop optical path by the diagnostic optical signal T_{L1} that varies in the variation range illustrated in FIG. 5.

In this case, the frequency of the diagnostic electric signal TE corresponds to the frequency of the mechanical vibration of the optical path switching unit, is determined for each individual optical switch element 10 from the mechanical structure of the optical path switching unit and the like, and corresponds to, for example, the resonance frequency of the mechanical vibration of the optical path switching unit.

In addition, in a case where an optical-waveguide optical switch element is used as the optical switch element 10, the optical intensity modulation is performed on the optical communication signal which is the output of the Add/Drop optical path by the diagnostic optical signal T_{L1} that varies in the variation range illustrated in FIG. 5 by applying the voltage of the diagnostic electric signal TE from the state setting unit 12 to the optical phase shift unit which is the movable portion of the waveguide configuration unit 11.

Eight optical demultiplexers 40 are arranged corresponding to the eight ports of the optical switch element 10.

In the following, in a case where the eight optical demultiplexers are described in common, they are collectively referred to as optical demultiplexer 40 in order to avoid complexity of description, and in a case where it is necessary to individually describe the optical demultiplexers, reference signs to distinguish the optical demultiplexers form each other are attached to reference sign 40.

Each optical demultiplexer 40 branches a part of the optical communication signal. A part of the optical communication signal branched by each optical demultiplexer 40 is input to a detection unit 31 in the switching availability diagnostic device 30 via an optical fiber.

The optical communication signal having passed through each optical demultiplexer 40 does not affect the double-ring optical network, and does not affect the terminal 1 in the optical communication station.

Each optical demultiplexer 40 is a commonly known optical coupler.

The optical demultiplexer 40Oa on the output side partially branches and propagates the optical communication signal from the first OUT port 10Oa of the optical switch element 10 to the optical communication station C via the first optical communication network, and propagates the partially branched optical communication signal to a first optical detection unit 31-1 in the detection unit 31 via the optical fiber.

The optical demultiplexer 40Ob on the output side partially branches and propagates the optical communication signal from the first DROP port 10Ob of the optical switch element 10 to the first optical transceiver 2A via the optical fiber, and propagates the partially branched optical communication signal to a second optical detection unit 31-2 in the detection unit 31 via the optical fiber.

The optical demultiplexer 40Oc on the output side partially branches and propagates the optical communication signal from the second OUT port 10Oc of the optical switch element 10 to the optical communication station B via the second optical communication network, and propagates the partially branched optical communication signal to a third optical detection unit 31-3 in the detection unit 31 via the optical fiber.

The optical demultiplexer 40Od on the output side partially branches and propagates the optical communication signal from the second DROP port 10Od of the optical switch element 10 to the second optical transceiver 2B via the optical fiber, and propagates the partially branched optical communication signal to a fourth optical detection unit 31-4 in the detection unit 31 via the optical fiber.

The optical demultiplexer 40Ia on the input side partially branches and propagates the optical communication signal from the optical communication station B to the first IN port 10Ia of the optical switch element 10 via the optical fiber, and propagates the partially branched optical communication signal to a sixth optical detection unit 31-6 in the detection unit 31 via the optical fiber.

The optical demultiplexer 40Ib on the input side partially branches and propagates the optical communication signal from the second optical transceiver 2B to the first ADD port 10Ib of the optical switch element 10 via the optical fiber, and propagates the partially branched optical communication signal to a fifth optical detection unit 31-5 in the detection unit 31 via the optical fiber.

The optical demultiplexer 40Ic on the input side partially branches and propagates the optical communication signal from the optical communication station C to the second IN port 10Ic of the optical switch element 10 via the optical fiber, and propagates the partially branched optical communication signal to an eighth optical detection unit 31-8 in the detection unit 31 via the optical fiber.

The optical demultiplexer 40Id on the input side partially branches and propagates the optical communication signal from the first optical transceiver 2A to the second ADD port 10Id of the optical switch element 10 via the optical fiber, and propagates the partially branched optical communication signal to a seventh optical detection unit 31-7 in the detection unit 31 via the optical fiber.

The switching availability diagnostic device 30 includes the detection unit 31 and the switching availability diagnostic unit 32.

The switching availability diagnostic device 30 operates when receiving a drive state signal indicating a switching availability diagnostic operation from the control unit 20.

The detection unit 31 receives optical communication signals which are output from the output ports of the optical switch element 10, that is, optical communication signals which are output from, in this example, the first OUT port 10Oa, the first DROP port 10Ob, the second OUT port 10Oc, and the second DROP port 10Od and on which diagnostic optical signals partially branched by the optical demultiplexers 40Oa to 40Od are superimposed at the time of the switching availability diagnosis. The detection unit converts the input optical communication signals into electric signals, and extracts an electric signal having a frequency equal to or lower than a set frequency from the converted electric signals as the diagnostic electric signal.

In addition, the detection unit 31 receives optical communication signals obtained by partially branching optical communication signals which are to be input to the input ports of the optical switch element 10, that is, to the first IN port 10Ia, the first ADD port 10Ib, the second IN port 10Ic, and the second ADD port 10Id in this example, by the optical demultiplexers 40Ia to 40Id at the time of the switching availability diagnosis. The detection unit 31 converts the input optical communication signals into electric signals, and extracts an electric signal having a frequency equal to or lower than a set frequency from the converted electric signals as a reference electric signal.

The set frequency in the detection unit 31 is the same as the cutoff frequency of the first optical transceiver 2A and the second optical transceiver 2B.

Therefore, the diagnostic electric signal extracted from the optical communication signals which are output from the output ports of the optical switch element 10 and partially branched by the optical demultiplexers 40Oa to 40Od at the time of the switching availability diagnosis is basically a signal obtained by converting the diagnostic optical signal into an electric signal.

However, when disturbance such as vibration derived from the installation environment occurs, the diagnostic electric signal also includes a signal based on the disturbance.

In addition, the reference electric signal extracted from the optical communication signals obtained by partially branching the optical communication signals which are to be input to the input ports of the optical switch element 10 by the optical demultiplexers 40Ia to 40Id at the time of the switching availability diagnosis is no-signal, that is, at zero potential.

However, when disturbance such as vibration derived from the installation environment occurs, the reference electric signal also includes a signal based on the disturbance.

The detection unit 31 includes the first optical detection unit 31-1 to the eighth optical detection unit 31-8 corresponding to the eight optical demultiplexers 40.

The first optical detection unit 31-1 receives the optical communication signal on which the diagnostic optical signal partially branched by the optical demultiplexer 40Oa at the time of the switching availability diagnosis is superimposed, converts the input optical communication signal into an electric signal, and extracts an electric signal having a frequency equal to or lower than a set frequency from the converted electric signal as the diagnostic electric signal.

That is, the first optical detection unit 31-1 objectively detects the optical connection state of the optical path from the first ADD port 10Ib to the first OUT port 10Oa in the Add/Drop optical path.

The second optical detection unit 31-2 receives the optical communication signal on which the diagnostic optical signal partially branched by the optical demultiplexer 40Ob at the time of the switching availability diagnosis is superimposed, converts the input optical communication signal into an electric signal, and extracts an electric signal having a frequency equal to or lower than a set frequency from the converted electric signal as the diagnostic electric signal.

That is, the second optical detection unit 31-2 objectively detects the optical connection state of the optical path from the first IN port 10Ia to the first DROP port 10Ob in the Add/Drop optical path.

The third optical detection unit 31-3 receives the optical communication signal on which the diagnostic optical signal partially branched by the optical demultiplexer 40Oc at the time of the switching availability diagnosis is superimposed, converts the input optical communication signal into an electric signal, and extracts an electric signal having a frequency equal to or lower than a set frequency from the converted electric signal as the diagnostic electric signal.

That is, the third optical detection unit 31-3 objectively detects the optical connection state of the optical path from the second ADD port 10Id to the second OUT port 10Oc in the Add/Drop optical path.

The fourth optical detection unit 31-4 receives the optical communication signal on which the diagnostic optical signal partially branched by the optical demultiplexer 40Od at the time of the switching availability diagnosis is superimposed, converts the input optical communication signal into an electric signal, and extracts an electric signal having a frequency equal to or lower than a set frequency from the converted electric signal as the diagnostic electric signal.

That is, the fourth optical detection unit 31-4 objectively detects the optical connection state of the optical path from the second IN port 10Ic to the second DROP port 10Od in the Add/Drop optical path.

The fifth optical detection unit 31-5 receives the optical communication signal on which the diagnostic optical signal partially branched by the optical demultiplexer 40Ib at the time of the switching availability diagnosis is superimposed, converts the input optical communication signal into an electric signal, and extracts an electric signal having a frequency equal to or lower than a set frequency from the converted electric signal as the reference electric signal.

That is, the fifth optical detection unit 31-5 detects a disturbance signal included in the optical communication signal to be input to the first ADD port 10Ib in the Add/Drop optical path.

The sixth optical detection unit 31-6 receives the optical communication signal on which the diagnostic optical signal partially branched by the optical demultiplexer 40Ia at the time of the switching availability diagnosis is superimposed, converts the input optical communication signal into an electric signal, and extracts an electric signal having a frequency equal to or lower than a set frequency from the converted electric signal as the reference electric signal.

That is, the sixth optical detection unit 31-6 detects a disturbance signal included in the optical communication signal to be input to the first IN port 10Ia.

The seventh optical detection unit 31-7 receives the optical communication signal on which the diagnostic optical signal partially branched by the optical demultiplexer 40Id at the time of the switching availability diagnosis is superimposed, converts the input optical communication signal into an electric signal, and extracts an electric signal having a frequency equal to or lower than a set frequency from the converted electric signal as the reference electric signal.

That is, the seventh optical detection unit 31-7 detects a disturbance signal included in the optical communication signal to be input to the second ADD port 10Id in the Add/Drop optical path.

The eighth optical detection unit 31-8 receives the optical communication signal on which the diagnostic optical signal partially branched by the optical demultiplexer 40Ic at the time of the switching availability diagnosis is superimposed, converts the input optical communication signal into an electric signal, and extracts an electric signal having a frequency equal to or lower than a set frequency from the converted electric signal as the reference electric signal.

That is, the eighth optical detection unit 31-8 detects a disturbance signal included in the optical communication signal to be input to the first IN port 10Ia.

Each of the first optical detection unit 31-1 to the eighth optical detection unit 31-8 includes a photodiode (PD) 31A, a transimpedance amplifier (TIA) 31B, and a filter (BPF) 31C as illustrated in FIG. 7.

The photodiode 31A receives the optical communication signal on which a partially branched diagnostic optical signal from the corresponding optical demultiplexer 40 is superimposed, and converts the input optical communication signal into an electric signal based on a current.

The transimpedance amplifier 31B amplifies the electric signal converted into a current by the photodiode 31A and converts the amplified electric signal into an electric signal based on a voltage.

The filter 31C in each of the first optical detection unit 31-1 to the fourth optical detection unit 31-4 extracts an electric signal having a frequency equal to or lower than a set frequency from the electric signal converted into a voltage by the transimpedance amplifier 31B as a diagnostic electric signal.

The filter 31C in each of the fifth optical detection unit 31-5 to the eighth optical detection unit 31-8 extracts an electric signal having a frequency equal to or lower than a set frequency from the electric signal converted into a voltage by the transimpedance amplifier 31B as a reference electric signal.

The filter 31C is a band-pass filter (BPF) or a low-pass filter (LPF) that sets the upper limit cutoff frequency to a frequency same as the cutoff frequency of the first optical transceiver 2A and the second optical transceiver 2B.

That is, in the filter 31C, a frequency equal to or lower than the cutoff frequency of the first optical transceiver 2A and the second optical transceiver 2B is set as a passband, and a band exceeding the cutoff frequency is set as a stopband.

Therefore, the electric signal based on the optical communication signal is cut and the electric signal based on the diagnostic optical signal is passed, and thus, the diagnostic electric signal or the reference electric signal is extracted by the filter 31C.

In a case where the optical switch element 10 is a MEMS optical switch element or a mechanical optical switch element, the center frequency of the filter 31C is determined on the basis of a mechanical vibration frequency unique to the optical path switching unit, because the frequency of the diagnostic electric signal TE corresponds to a resonance frequency determined for each individual from the mechanical structure of the optical path switching unit which is the state setting unit 12, etc.

The band-pass filter or the low-pass filter is constituted by an analog circuit.

Note that the detection unit 31 is preferably incorporated in the optical switch element 10, that is, formed as a module by being integrated on a semiconductor substrate on which the waveguide configuration unit 11 and the like are integrated. In this case, the integrated components are the photodiode 31A, a set of the photodiode 31A and the transimpedance amplifier 31B, or a set of the photodiode 31A, the transimpedance amplifier 31B, and the filter 31C.

In addition, each of the first optical detection unit 31-1 to the eighth optical detection unit 31-8 is not limited to include the photodiode 31A, the transimpedance amplifier 31B, and the filter 31C as long as it extracts a frequency component in a frequency band equal to or lower than the cutoff frequency from the optical power of the optical communication signal on which the diagnostic optical signal partially branched from the optical demultiplexer 40 is superimposed and outputs the frequency component as an electric signal.

The switching availability diagnostic unit 32 compares the amplitude value of the diagnostic electric signal extracted by the detection unit 31 with a set threshold. The switching availability diagnostic unit 32 determines that a normal state is established when the amplitude value of the diagnostic electric signal is equal to or greater than the threshold, and determines that there is a possibility that the optical path is non-switchable when the amplitude value is less than the threshold.

In the first embodiment, the amplitude value of the diagnostic electric signal to be compared to the threshold by the switching availability diagnostic unit 32 is a difference value between the amplitude value at the output port from which the diagnostic electric signal is extracted and the amplitude value of the reference electric signal with respect to the input port corresponding to the output port.

The switching availability diagnostic unit 32 includes a calculation unit 321 and a determination unit 322.

The calculation unit 321 obtains a difference value between the amplitude value of the diagnostic electric signal extracted by the detection unit 31 and the amplitude value of the reference electric signal with respect to the input port corresponding to the output port from which the diagnostic electric signal is extracted, and obtains a difference output obtained by amplifying the difference value.

The calculation unit 321 calculates a first difference value between the amplitude of the diagnostic electric signal extracted by the first optical detection unit 31-1 and the amplitude of the reference electric signal extracted by the fifth optical detection unit 31-5, and obtains an amplified first difference output.

The first difference value corresponds to an amplitude value of the diagnostic electric signal based on the diagnostic optical signal which is output from the first OUT port 10Oa and from which the disturbance signal in the optical path from the first ADD port 10Ib to the first OUT port 10Oa in the Add/Drop optical path has been removed.

The calculation unit 321 calculates a second difference value between the amplitude value of the diagnostic electric signal extracted by the second optical detection unit 31-2 and the amplitude value of the reference electric signal extracted by the sixth optical detection unit 31-6, and obtains an amplified second difference output.

The second difference value corresponds to an amplitude value of the diagnostic electric signal based on the diagnostic optical signal which is output from the first DROP port 10Ob and from which the disturbance signal in the optical path from the first IN port 10Ia to the first DROP port 10Ob in the Add/Drop optical path has been removed.

The calculation unit 321 calculates a third difference value between the amplitude of the diagnostic electric signal extracted by the third optical detection unit 31-3 and the amplitude value of the reference electric signal extracted by the seventh optical detection unit 31-7, and obtains an amplified third difference output.

The third difference value corresponds to an amplitude value of the diagnostic electric signal based on the diagnostic optical signal which is output from the second OUT port 10Oc and from which the disturbance signal in the optical path from the second ADD port 10Id to the second OUT port 10Oc in the Add/Drop optical path has been removed.

The calculation unit 321 calculates a fourth difference value between the amplitude value of the diagnostic electric signal extracted by the fourth optical detection unit 31-4 and the amplitude value of the reference electric signal extracted by the eighth optical detection unit 31-8, and obtains an amplified fourth difference output.

The fourth difference value corresponds to an amplitude value of the diagnostic electric signal based on the diagnostic optical signal which is output from the second DROP port 10Od and from which the disturbance signal in the optical path from the second IN port 10Ic to the second DROP port 10Od in the Add/Drop optical path has been removed.

The determination unit 322 compares each of the first difference output to the fourth difference output obtained by the calculation unit 321 with the set threshold. When the difference output corresponding to the amplitude value of the diagnostic electric signal is equal to or greater than the threshold, the determination unit 322 determines that a normal state is established, and when the difference corresponding to the amplitude value of the diagnostic electric signal is less than the threshold, the determination unit 322 determines that there is a possibility that switching between the Add/Drop optical path in the Add/Drop state and the Bypass optical path in the Bypass state cannot be performed.

When the determination unit 322 determines that there is a possibility that the optical path cannot be switched, a user is notified of this situation. For example, an external system or the user is notified of this situation by an alarm issued to a host system via the terminal 1 or the optical communication station A, an increase or a decrease in an alarm output contact voltage level in the terminal 1, or a lamp provided in the terminal 1 being lighted.

In a case where the determination unit 322 determines that there is a possibility that the optical path cannot be switched, it is conceivable that a failure of the state setting unit 12 occurs. For example, in a case where the optical switch element 10 is a MEMS optical switch element or a mechanical optical switch element, it is conceivable that a movable portion such as an electromagnetic relay is immobile and fixed due to dust in the movable portion, or in a case where the optical switch element 10 is an optical-waveguide optical switch element, it is conceivable that a failure occurs in an electrical system in the optical phase shift unit. Thus, the switching availability diagnostic device can be used for diagnosing a failure of the optical switch element 10.

In short, as long as the determination unit 322 determines that a normal state is established, that is, switching from the Add/Drop optical path to the Bypass optical path can be performed, the optical switch element 10 can surely disconnect the optical communication station A from the double-ring optical network, when a failure or a power failure occurs or an inspection is needed in the optical communication station A.

In addition, when the determination unit 322 determines that there is a possibility that the switching of the optical path cannot be performed, it is possible to promptly respond to the failure determination of the optical switch element 10.

Note that, in the switching availability diagnostic device 30, the switching availability diagnostic unit 32 determines whether or not switching can be performed by comparing the difference value between the amplitude value of the diagnostic electric signal extracted by the detection unit 31 and the amplitude value of the reference electric signal with the threshold, but the switching availability diagnostic unit 32 may determine the switching availability by comparing the amplitude value of the diagnostic electric signal with the threshold without extracting the reference electric signal.

In this case, the optical communication signal obtained by partially branching the optical communication signal subjected to optical intensity modulation by the diagnostic optical signal T_{L1} is also used to determine whether or not the switching of the optical path can be performed, and thus, it is possible to sufficiently determine whether or not the switching from the Add/Drop optical path to the Bypass optical path can be performed without being affected by disturbance such as vibration derived from the installation environment.

In addition, the switching availability diagnostic device 30 extracts, by the detection unit 31, the diagnostic electric signals based on the optical communication signals which are output from the four output ports that are the first OUT port 10Oa, the first DROP port 10Ob, the second OUT port 10Oc, and the second DROP port 10Od and on which the diagnostic optical signals partially branched by the optical demultiplexers 40Oa to 40Od are superimposed, and determines, by the switching availability diagnostic unit 32, whether or not switching can be performed for all the diagnostic electric signals. However, the switching availability diagnostic device 30 may extract the diagnostic electric signal based on the optical communication signal which is output from at least one output port among the four output ports and on which the diagnostic optical signal partially branched by the optical demultiplexer 40 is superimposed, and determine whether or not switching can be performed for the extracted diagnostic electric signal by the switching availability diagnostic unit 32.

Next, the operation of the optical switch device including the switching availability diagnostic device according to the first embodiment will be described.

When the control unit 20 receives a signal indicating the Bypass state which is a normal operation during a non-operating state, the low-level drive signal V_{LOW} is supplied to the state setting unit 12 as indicated in the region (I) illustrated in FIG. 4, and the state setting unit 12 performs an operation of holding the optical path of the waveguide configuration unit 11 as the Bypass optical path illustrated in FIG. 3.

At this time, the control unit 20 outputs a drive state signal indicating the normal operation to the switching availability diagnostic device 30. Therefore, the switching availability diagnostic device 30 does not operate.

When the control unit 20 receives a signal indicating the Add/Drop state which is a normal operation during an operating state, the high-level drive signal V_{HIGH} is supplied to the state setting unit 12 as indicated in the region (II) illustrated in FIG. 4, and the state setting unit 12 performs an operation of holding the optical path of the waveguide configuration unit 11 as the Add/Drop optical path illustrated in FIG. 2.

At this time, the control unit 20 outputs a drive state signal indicating the normal operation to the switching availability diagnostic device 30. Therefore, the switching availability diagnostic device 30 does not operate.

On the other hand, when the control unit 20 supplies the diagnostic electric signal TE illustrated in FIG. 5 to the state setting unit 12 at the time of the switching availability diagnosis in the Add/Drop state in which the optical switch element 10 is held as the Add/Drop optical path, an optical communication signal obtained by performing optical intensity modulation on the optical communication signal that is the output of the Add/Drop optical path by the diagnostic optical signal T_{L1} varying in a variation range illustrated in FIG. 5 is output from the output port of the Add/Drop optical path, that is, an optical communication signal obtained by superimposing the diagnostic optical signal T_{L1} on the optical communication signal is output from the output port of the waveguide configuration unit 11.

At this time, the control unit 20 outputs the drive state signal indicating the switching availability diagnostic operation to the switching availability diagnostic device 30, whereby the switching availability diagnostic device 30 is activated and operates.

The optical signal having passed through the optical demultiplexer 40 and having subjected to the optical intensity modulation by the diagnostic optical signal T_{L1} is optically received and transmitted without affecting the double-ring optical network. Further, the diagnostic optical signal T_{L1} has a frequency cut by the first optical transceiver 2A and the second optical transceiver 2B in the optical communication station, and thus does not also affect the terminal 1.

The optical communication signals partially branched by the optical demultiplexers 40Oa to 40Od are extracted as the diagnostic electric signals based on the diagnostic optical signals T_{L1} by the first optical detection unit 31-1 to the fourth optical detection unit 31-4.

In addition, the optical communication signals partially branched by the optical demultiplexers 40Ia to 40Id are extracted as the reference electric signals by the fifth optical detection unit 31-5 to the eighth optical detection unit 31-8.

The calculation unit 321 calculates the first difference value that is a difference between the amplitude of the diagnostic electric signal extracted by the first optical detection unit 31-1 and the amplitude value of the reference electric signal extracted by the fifth optical detection unit 31-5, the second difference value that is a difference between the amplitude value of the diagnostic electric signal extracted by the second optical detection unit 31-2 and the amplitude value of the reference electric signal extracted by the sixth optical detection unit 31-6, the third difference value that is a difference between the amplitude value of the diagnostic electric signal extracted by the third optical detection unit 31-3 and the amplitude value of the reference electric signal extracted by the seventh optical detection unit 31-7, and the fourth difference value that is a difference between the amplitude value of the diagnostic electric signal extracted by the fourth optical detection unit 31-4 and the amplitude value of the reference electric signal extracted by the eighth optical detection unit 31-8, and amplifies the obtained difference values.

The determination unit 322 compares each of the first difference output to the fourth difference output obtained by the calculation unit 321 with the set threshold. When the difference output corresponding to the amplitude value of the diagnostic electric signal is equal to or greater than the threshold, the determination unit 322 determines that a normal state is established, and when the difference corresponding to the amplitude value of the diagnostic electric signal is less than the threshold, the determination unit 322 determines that there is a possibility that switching between the Add/Drop optical path in the Add/Drop state and the Bypass optical path in the Bypass state cannot be performed.

When the determination unit 322 determines that there is a possibility that the optical path cannot be switched, a user is notified of this situation.

As described above, the switching availability diagnostic device 30 of the optical switch element 10 according to the first embodiment includes: the detection unit 31 that converts an optical communication signal into an electric signal, the optical communication signal being partially branched from an optical communication signal on which a diagnostic optical signal having a frequency lower than a frequency of an optical communication signal output from an output port of the optical switch element 10 is superimposed, and extracts an electric signal having a frequency equal to or lower than a set frequency from the converted electric signal as a diagnostic electric signal; and the switching availability diagnostic unit 32 that compares an amplitude value of the diagnostic electric signal extracted by the detection unit 31 with a threshold, the switching availability diagnostic unit 32 determining that a normal state is established when the amplitude value of the diagnostic electric signal is equal to or greater than the threshold and determining that there is a possibility that the optical path is non-switchable when the amplitude value is less than the threshold. The switching availability diagnostic device 30 detects and uses the diagnostic optical signal with a low frequency that modulates the optical communication signal for determining the switching availability, and thus, can determine whether or not the optical switch element 10 can be switched with an influence of disturbance being suppressed.

As a result, the switching availability diagnostic device 30 can be used to determine a failure of the optical switch element 10.

In the switching availability diagnostic device 30 of the optical switch element 10 according to the first embodiment, the detection unit 31 converts an optical communication signal partially branched from an optical communication signal to be input to an input port corresponding to the output port of the optical switch element 10, and extracts an electric signal having a frequency equal to or lower than a set frequency from the converted electric signal as a reference electric signal, and the switching availability diagnostic unit 32 includes: the calculation unit 321 that obtains a difference value between an amplitude value of the diagnostic electric signal extracted by the detection unit 31 and an amplitude value of the reference electric signal; and the determination unit 322 that compares the difference value obtained by the calculation unit 321 with the threshold and performs determination. Therefore, the switching availability diagnostic device 30 can suppress an influence of disturbance such as a fluctuation in power of an optical communication signal and surrounding vibration, and can determine whether or not the optical switch element 10 can be switched with high precision.

In the switching availability diagnostic device 30 of the optical switch element 10 according to the first embodiment, the detection unit 31 includes a photodiode, a transimpedance amplifier, and a filter, whereby the circuit configuration can be simplified.

In addition, the amplitude value of the diagnostic electric signal extracted by the filter is compared with the threshold and the determination is performed. This simplifies calculation processing in the switching availability diagnostic unit 32.

In addition, the optical switch device 100 including the switching availability diagnostic device 30 of the optical switch element 10 according to the first embodiment has the same effect as that of the switching availability diagnostic device 30.

The optical switch device 100 sets the frequency of the diagnostic optical signal that modulates the optical communication signal used for determining whether or not switching can be performed to be lower than the cutoff frequency of each of the first optical transceiver 2A and the second optical transceiver 2B, and sets the frequency in the detection unit to be lower than the cutoff frequency of each of the first optical transceiver 2A and the second optical transceiver 2B. Therefore, even when a terminal to which the optical switch element 10 is connected is in operation, the optical switch device 100 can determine whether or not switching of the optical switch element 10 can be performed without interrupting the optical communication and without affecting the terminal 1 and the communication network.

The optical switch device 100 uses, as the diagnostic drive signal for superimposing the diagnostic optical signal on the optical communication signal, an electric signal that varies between a voltage for holding the optical path in the add/drop state and the lower limit voltage lower than the holding voltage by a set voltage. Therefore, the diagnostic drive signal is an electric signal sufficient for superimposing the diagnostic optical signal having a frequency lower than the frequency of the optical communication signal on the optical communication signal, whereby the diagnostic optical signal is easily detected.

In the optical switch device 100, the control unit 20 autonomously supplies the diagnostic drive signal to the state setting unit 12, whereby the timing of the switching diagnosis can be determined by the optical switch element 10 alone without being affected by the terminal 1 or the like.

It is to be noted that any components in the embodiment can be modified or omitted.

### INDUSTRIAL APPLICABILITY

The switching availability diagnostic device that determines whether or not an optical switch element is switchable according to the present disclosure can be used as a switching availability diagnostic device for a mechanical-relay optical switch element, a micro-electro-mechanical systems optical switch element, and an optical-waveguide optical switch element.

In addition, the optical switch device having the switching availability diagnostic device according to the present disclosure is suitable as an optical switch device used for an optical communication network, particularly for a double-ring optical communication network.

### REFERENCE SIGNS LIST

1: Terminal, 2A: First optical transceiver, 2B: Second optical transceiver, 100: Optical switch device, 10: Optical switch element, 11: Waveguide configuration unit, 12: State setting unit (State setting circuit), 20: Control unit (Controller), 30: Switching availability diagnostic device, 31: Detection unit (Detector), 31-1 to 31-8: First optical detection unit to Eighth optical detection unit, 31A: Photodiode, 31B: Transimpedance amplifier, 31C: filter, 32: Switching availability diagnostic unit (Switching availability diagnostic circuit), 321: Calculation unit (Calculator), 322: Determination unit (Determination circuit), 40Oa to 40Od and 40Ia to 40Id: Optical demultiplexer

What is claimed is:

1. A switching availability diagnostic device comprising:
a detector to receive a partial optical communication signal branched from an optical communication signal on which a diagnostic optical signal having a frequency lower than a frequency of an optical communication signal output from an output port of an optical switch element is superimposed, the optical switch element having an optical path from an input port to an output port, the optical path being switchable, convert the input partial optical communication signal into an electric signal, and extract an electric signal having a frequency equal to or lower than a set frequency from the converted electric signal as a diagnostic electric signal, the detector receiving a partial optical communication signal branched from an optical communication signal to be input to an input port corresponding to the output port of the optical switch element from which the diagnostic electric signal has been extracted, converting the input partial optical communication signal into an electric signal, and extracting an electric signal having a frequency equal to or lower than a set frequency from the converted electric signal as a reference electric signal; and
a determination circuit to compare a difference value between an amplitude value of the diagnostic electric signal extracted by the detector and an amplitude value of the reference electric signal with a set threshold, the determination circuit determining that a normal state is established when the difference value between amplitude values is equal to or greater than the threshold and determining that there is a possibility that switching of the optical path is impossible when the difference value between amplitude values is less than the threshold.

2. A switching availability diagnostic device comprising:
a detector to receive a partial optical communication signal branched from an optical communication signal on which a diagnostic optical signal having a frequency lower than a frequency of an optical communication signal output from an output port of an optical switch element is superimposed, the optical switch element including M (a natural number equal to or more than 1) input ports and N (a natural number equal to or more than 2) output ports and being switchable to either of two states that are an add/drop state and a bypass state, convert the input partial optical communication signal into an electric signal, and extract an electric signal having a frequency equal to or lower than a set frequency from the converted electric signal as a diagnostic electric signal, the detector receiving a partial optical communication signal branched from an optical communication signal to be input to an input port corresponding to the output port of the optical switch element from which the diagnostic electric signal has been extracted, converting the input partial optical communication signal into an electric signal, and extracting an electric signal having a frequency equal to or lower than a set frequency from the converted electric signal as a reference electric signal; and
a switching availability diagnostic circuit including: a calculator to obtain a difference value between an amplitude value of the diagnostic electric signal extracted by the detector and an amplitude value of the reference electric signal; and a determination circuit to compare the difference value obtained by the calculator with a set threshold, the switching availability diagnostic circuit determining that a normal state is established when the difference value between amplitude values is equal to or greater than the threshold and determining that there is a possibility that switching between the two states is impossible when the difference value between amplitude values is less than the threshold.

3. The switching availability diagnostic device according to claim 1, wherein
the detector includes:
a photodiode to convert an optical communication signal to which the partial optical communication signal branched from the optical communication signal on which the diagnostic optical signal is superimposed is input into an electric signal;
a transimpedance amplifier to amplify an electric signal converted into a current by the photodiode and convert the electric signal into an electric signal based on a voltage; and
a filter to extract an electric signal having a frequency equal to or lower than a set frequency from the electric signal from the transimpedance amplifier as the diagnostic electric signal.

4. The switching availability diagnostic device according to claim 3, wherein the filter is either a band-pass filter or a low-pass filter having the set frequency as an upper limit cutoff frequency.

5. The switching availability diagnostic device according to claim 3, wherein the filter includes an analog electric circuit.

6. An optical switch device comprising:
an optical switch element including a waveguide configuration circuit that has M (a natural number equal to or more than 1) input ports and N (a natural number equal to or more than 2) output ports, is switchable to either of two states that are an add/drop state and a bypass state, and includes M waveguides corresponding to the M input ports and N waveguides corresponding to the N output ports, and a state setting circuit to cause the waveguide configuration circuit to hold either of the two states when receiving a drive signal and cause the waveguide configuration circuit to superimpose a diagnostic optical signal on an optical communication signal output from at least one of the N output ports when receiving a diagnostic drive signal, the diagnostic optical signal having a frequency equal to or lower than a frequency of the optical communication signal; and
a switching availability diagnostic device including a detector to receive a partial optical communication signal branched from the optical communication signal which is output from the output port of the waveguide configuration circuit of the optical switch element and on which the diagnostic optical signal is superimposed, convert the input partial optical communication signal into an electric signal, and extract an electric signal having a frequency equal to or lower than a set frequency from the converted electric signal as a diagnostic electric signal, and a switching availability diagnostic circuit to compare an amplitude value of the diagnostic electric signal extracted by the detector with a set threshold, the switching availability diagnostic circuit determining that a normal state is established when the amplitude value of the diagnostic electric signal is equal to or greater than the threshold and determining that there is a possibility that switching between the two states is impossible when the amplitude value is less than the threshold.

7. The optical switch device according to claim 6, wherein
the detector includes:
a photodiode to convert an optical communication signal to which the partial optical communication signal branched from the optical communication signal on which the diagnostic optical signal is superimposed is input into an electric signal;
a transimpedance amplifier to amplify an electric signal converted into a current by the photodiode and convert the electric signal into an electric signal based on a voltage; and
a filter to extract an electric signal having a frequency equal to or lower than a set frequency from the electric signal from the transimpedance amplifier as the diagnostic electric signal.

8. An optical switch device comprising:
an optical switch element including a waveguide configuration circuit that has a first input port connected to a first optical communication network, a first add port connected to a second optical transceiver, a second input port connected to a second optical communication network, a second add port connected to a first optical transceiver, a first output port connected to the first optical communication network, a first drop port connected to the first optical transceiver, a second output port connected to the second optical communication network, and a second drop port connected to the second optical transceiver, forms an add/drop optical path including an optical path from the first input port to the first drop port, an optical path from the first add port to the first output port, an optical path from the second input port to the second drop port, and an optical path from the second add port to the second output port in an add/drop state, and forms a bypass optical path including an optical path from the first input port to the first output port and an optical path from the second input port to the second output port in a bypass state, and a state setting circuit to cause the waveguide configuration circuit to hold either the add/drop state or the bypass state when receiving a drive signal, and cause the waveguide configuration circuit to superimpose a diagnostic optical signal on an optical communication signal output from at least one of the first output port, the first drop port, the second output port, and the second drop port when receiving a diagnostic drive signal, the diagnostic optical signal having a frequency lower than a frequency of the optical communication signal; and
a switching availability diagnostic device including a detector to receive a partial optical communication signal branched from the optical communication signal which is output from the output port of the waveguide configuration circuit of the optical switch element and on which the diagnostic optical signal is superimposed, convert the input partial optical communication signal into an electric signal, and extract an electric signal having a frequency equal to or lower than a set frequency from the converted electric signal as a diagnostic electric signal, and a switching availability diagnostic circuit to compare an amplitude value of the diagnostic electric signal extracted by the detector with a set threshold, the switching availability diagnostic circuit determining that a normal state is established when the amplitude value of the diagnostic electric signal is equal to or greater than the threshold and determining that there is a possibility that switching between the two states is impossible when the amplitude value is less than the threshold.

9. The optical switch device according to claim 8, wherein a frequency of the diagnostic optical signal is less than a cutoff frequency of each of the first optical transceiver and the second optical transceiver, and
the set frequency in the detector is less than the cutoff frequency of each of the first optical transceiver and the second optical transceiver.

10. The optical switch device according to claim 8, wherein
the detector extracts, as a reference electric signal, an electric signal having a frequency equal to or lower than a set frequency from an electric signal obtained by conversion of a partial optical communication signal branched from an optical communication signal to be input to the first input port or the first add port when acquiring the diagnostic optical signal from the first output port, extracts, as a reference electric signal, an electric signal having a frequency equal to or lower than a set frequency from an electric signal obtained by conversion of a partial optical communication signal branched from an optical communication signal to be input to the first input port when acquiring the diagnostic optical signal from the first drop port, extracts, as a reference electric signal, an electric signal having a frequency equal to or lower than a set frequency from an electric signal obtained by conversion of a partial optical communication signal branched from an optical communication signal to be input to the second input port or the second add port when acquiring the diagnostic optical signal from the second drop port, and extracts, as a reference electric signal, an electric signal having a frequency equal to or lower than a set frequency from an electric signal obtained by conversion of a partial optical communication signal branched from an optical communication signal to be input to the second input port when acquiring the diagnostic optical signal from the second drop port, and
the switching availability diagnostic circuit includes: a calculator to obtain a difference value between an amplitude value of the diagnostic electric signal extracted by the detector and an amplitude value of corresponding one of the reference electric signals; and a determination circuit to compare the difference value obtained by the calculator with the threshold and perform determination.

11. The optical switch device according to claim 8, wherein
the detector includes:
a photodiode to convert an optical communication signal to which a partial optical communication signal branched from the optical communication signal on which the diagnostic optical signal is superimposed is input into an electric signal;
a transimpedance amplifier to amplify an electric signal converted into a current by the photodiode and convert the electric signal into an electric signal based on a voltage; and
a filter to extract an electric signal having a frequency equal to or lower than a set frequency from the electric signal from the transimpedance amplifier as the diagnostic electric signal.

12. The optical switch device according to claim 11, wherein the filter is either a band-pass filter or a low-pass filter having the set frequency as an upper limit cutoff frequency that is equal to a cutoff frequency of each of the first optical transceiver and the second optical transceiver.

13. The optical switch device according to claim 11, wherein the filter includes an analog electric circuit.

14. The optical switch device according to claim 11, wherein at least the photodiode among the photodiode, the transimpedance amplifier, and the filter is incorporated in the optical switch element.

15. The optical switch device according to claim 8, wherein the diagnostic drive signal is an electric signal that varies between a holding voltage for holding an optical path in the add/drop state and a lower limit voltage lower than the holding voltage by a set voltage.

16. The optical switch device according to claim 8, further comprising
a controller to supply the diagnostic drive signal to the state setting circuit, wherein
the controller autonomously determines a timing of supplying the diagnostic drive signal to the state setting circuit.

17. The optical switch device according to claim 8, further comprising
a controller to supply the diagnostic drive signal to the state setting circuit, wherein
the controller constantly supplies the diagnostic drive signal to the state setting circuit during the add/drop state.

18. The optical switch device according to claim 8, wherein the optical switch element is a mechanical optical switch element that is either a mechanical-relay optical switch element or a micro-electro-mechanical systems optical switch element.

19. The optical switch device according to claim 18, wherein a frequency of the diagnostic drive signal is set corresponding to a frequency of mechanical vibration in the state setting circuit of the mechanical optical switch element.

20. The optical switch device according to claim 11, wherein the optical switch element is a mechanical optical switch element that is either a mechanical-relay optical switch element or a micro-electro-mechanical systems optical switch element,
a frequency of the diagnostic drive signal is set corresponding to a frequency of mechanical vibration in the state setting circuit of the mechanical optical switch element, and
a center frequency of the filter is set by a unique frequency of mechanical vibration of the state setting circuit.

21. The optical switch device according to claim 8, wherein the optical switch element is an optical-waveguide optical switch element.
